(19) United States
(12) Patent Application Publication
(10) Pub. No.: US 2026/0214488 A1
(43) Pub. Date: Jul. 23, 2026

(54) CSI REPORTING BY USER DEVICE OF A NUMBER OF BEAMS OF NETWORK NODES IN A JOINT TRANSMISSION

(71) Applicant: Lenovo (Singapore) Pte. Ltd., Singapore (SG)

(72) Inventors: AHMED HINDY, AURORA, IL (US); VIJAY NANGIA, WOODRIDGE, IL (US)

(21) Appl. No.: 19/142,628

(22) PCT Filed: Dec. 22, 2023
(86) PCT No.: PCT/IB2023/063153

§ 371 Date: Jun. 23, 2025

Related U.S. Application Data
(60) Provisional application No. 63/476,845, filed on Dec. 22, 2022.

(51) Int. Cl. H04W 24/10; H04B 7/06; H04L 5/00

(52) U.S. Cl. CPC H04W 24/10; H04B 7/0626; H04L 5/0048

(57) ABSTRACT

Various aspects of the present disclosure relate to devices and methods for simultaneous transmissions of channel state information (CSI) reference signals (RS) by base stations (BSs) at remote locations in a coordination cluster. The BSs correspond to a set of channel measurement resource (CMR) segments of a CMR. A user equipment (UE) receives the set and beam combinations of numbers of beams for each BS of the set along with pre-determined uplink resources corresponding to uplink control information (UCI) and channel-based CSI report size. The size is based on a count of the set of CMR segments and the respective number of beams for each BS. The UE selects a subset of the set and one beam combination, adjusting mismatches in a generated CSI report to match the predetermined resources. The BS is aware of the adjustments based on configuration of the UE and/or uplink indications by the UE.

This application claims priority to U.S. provisional application No. 63/476,845, filed Dec. 22, 2022, the content of which is incorporated herein by reference.

### TECHNICAL FIELD

The present disclosure relates to wireless communications, and more specifically to channel state information reporting for wireless communication that uses simultaneous transmissions from remote locations in a coordination cluster.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

In wireless communications, channel state information (CSI) is the known channel properties of a communication link. The CSI needs to be estimated at the receiver and usually quantized and feedback to the transmitter. The CSI describes how a signal propagates from the transmitter to the receiver and represents the combined effect of, for example, scattering, fading, and power decay with distance using a channel estimation method. The CSI enables adapting transmissions to current channel conditions, which is crucial for achieving reliable communication with high data rates in multiple-antenna systems. User equipment (UE) is typically at a disadvantage as compared to network devices with regard to transmit power and available antenna combinations to support simultaneous transmissions. With the introduction of multiple-point transmissions by networks to increase coverage, reliability, and data throughput, networks and UEs need to measure CSI for increased combinations of network devices that can simultaneously transmit to each UE. The increased combinations of network devices with corresponding numbers of beams per network device creates additional overhead for control signaling to schedule resources for CSI reporting.

### SUMMARY

The present disclosure relates to methods, apparatuses, and systems that provide increased communication coverage, reliability and throughput by using multiple network devices at remote locations in a coordination cluster that simultaneously transmits to a user device. Efficient control signaling for channel state information (CSI) is achieved with collaboration by a network device and the user device in selecting network devices and number of beams per network device. The user device adjusts CSI reporting to match uplink resources. Some implementations of the method and apparatuses described herein may include a method for wireless communication at a user device. In one or more embodiments, the method includes receiving, from at least one network device via at least one transceiver of a device, a first configuration message that configures the device to perform channel measurements over a set of CSI reference signal (RS) resources. The method includes receiving, in the first configuration message, two or more beam combinations, each beam combination assigning a respective value of a number of beams associated with each CSI-RS resource. The method includes selecting, based on reception capabilities of the device and the channel measurements over the set of CSI-RS resources, (i) a subset of the set of the CSI-RS resources and (ii) a selected beam combination of the two or more beam combinations. The method includes adjusting the number of beams corresponding to the selected beam combination, based on the selection of the subset of the set of the CSI-RS resources and a value corresponding to the selected beam combination of the two or more beam combinations. The method includes generating a CSI report that includes: (i) a first part having a first indication of the subset and a second indication of a selected beam combination of the two or more beam combinations; and (ii) a second part containing CSI corresponding to the subset of the set of CSI-RS resources. The method includes reporting the CSI report via the transceiver to the at least one network device.

Some implementations of the method and apparatuses described herein may include a method for wireless communication at a network device. In one or more embodiments, the method includes transmitting, via at least one transceiver to a user device of at least one user device, a first configuration message that configures the user device to perform channel measurements over a set of CSI-RS resources. The method includes transmitting, in the first configuration message, two or more beam combinations, each beam combination assigning a respective value of a number of beams associated with each CSI-RS resource. The first configuration message prompts the user device to select, based on reception capabilities of the user device and the channel measurements over the set of CSI-RS resources, (i) a subset of the set of the CSI-RS resources and (ii) a selected beam combination of the two or more beam combinations. The first configuration message prompts the user device to adjust the number of beams corresponding to the selected beam combination, based on the selection of the subset of the set of the CSI-RS resources and a value corresponding to the selected beam combination of the two or more beam combinations. The method includes receiving, via the at least one transceiver from the user device, a CSI report that includes: (i) a first part having a first indication of the subset and a second indication of a selected beam combination of the two or more beam combinations; and (ii) a second part containing CSI corresponding to the subset of the set of CSI-RS resources.

### BRIEF DESCRIPTION OF THE DRAWINGS

FIG. 1 is an example of a wireless communications system enabling efficient control signaling for channel state information (CSI) with collaboration by a network device and the user device including adjustment of CSI reporting to match uplink resources, in accordance with aspects of the present disclosure.

FIG. 2 is a diagram of aperiodic trigger state defining a list of CSI report settings, in accordance with aspects of the present disclosure.

FIG. 3 is example program code for aperiodic trigger that indicates the resource set and quasi co-located (QCL) information, in accordance with aspects of the present disclosure.

FIG. 4 depicts the radio resource control (RRC) configuration for non-zero power (NZP) CSI resource signals/CSI interference management (IM) resources, in accordance with aspects of the present disclosure.

FIG. 5 is a diagram of partial CSI omission for Release 15 physical uplink shared channel (PUSCH)-based CSI, in accordance with aspects of the present disclosure.

FIG. 6 is an example of first embodiment of abstract syntax notation one (ASN.1) code for CSI report configuration (“CSI-ReportConfig”) Reporting Setting information element (IE) with multiple transmission reception point (TRP) transmission indication, in accordance with aspects of the present disclosure.

FIG. 7 is an example of a second embodiment of ASN.1 code for CSI-ReportConfig Reporting Setting IE with multi-TRP transmission indication, in accordance with aspects of the present disclosure.

FIG. 8 is an example of a third embodiment of ASN.1 code for triggering more than one channel measurement resource (CMR) group in an NZP CSI-RS Resource Set Configuration IE, in accordance with aspects of the present disclosure.

FIG. 9 is an example of a fourth embodiment of ASN.1 code for triggering two CSI Reports within CodebookConfig Codebook Configuration IE, in accordance with aspects of the present disclosure.

FIG. 10 is an example of a fifth embodiment of ASN.1 code for triggering two CSI Reports within CSI-ReportConfig Reporting Setting IE, in accordance with aspects of the present disclosure.

FIG. 11 is an example of a sixth embodiment of ASN.1 code for triggering two CSI Reports within CSI-ReportConfig Reporting Setting IE, in accordance with aspects of the present disclosure.

FIG. 12 illustrates a block diagram of a user device that performs simultaneous reception with network devices of a coordination cluster, in accordance with aspects of the present disclosure.

FIG. 13 illustrates a block diagram of a network device that performs simultaneous transmission via a coordination cluster to a user device, in accordance with aspects of the present disclosure.

FIG. 14 illustrates a flowchart of a method performed by a user device for performing simultaneous reception with network transmitters at remote locations of a coordination cluster, in accordance with aspects of the present disclosure.

FIG. 15 illustrates a flowchart of a method performed by a network device for performing simultaneous transmission via network transmitters at remote locations of a coordination cluster, in accordance with aspects of the present disclosure.

### DETAILED DESCRIPTION

Coverage, data throughput, and system reliability are fundamental aspects of cellular network deployments. Recent radio access technologies (RATs) have added support for coordination clusters within a cell coverage area to overcome poor communication channel conditions. Simultaneous, coordinated transmissions from network devices at remote locations enhance likelihood of successful communication with a user device supported by the cell coverage area. The network devices may be antenna panels, network nodes, remote radio heads (RRHs), or transmission reception points (TRPs). The user device such as user equipment (UE) may have varying capabilities to receive simultaneous transmission to take advantage of the network capability for simultaneous transmissions.

Communicating with the same UE via multiple network devices comes at the expense of excessive control signaling between the network side and the UE side to arrive at an optimum or best transmission configuration. In an example, control signaling is required to determine whether or not to support multiple-point transmission. If multiple-point transmission is indicated, additional control signaling is required to determine which combination of network devices should operate simultaneously. With various combinations to measure, an amount of channel state information (CSI) feedback from the UE to the network increases substantially more than a mere linear increase in proportion to the number of network devices. In addition, a distinct codebook may be needed for each point. In an example, a number of precoder matrix indicator (PMI) bits feedback from the UE via uplink control information (UCI) can be very large, exceeding 1000 bits at a large bandwidth, even for a single-point transmission. The purpose of multiple-point transmission is to improve the spectral efficiency, as well as the reliability and robustness of the connection in different scenarios. Support for multiple-point transmission should cover both ideal and nonideal backhaul.

In the presence of joint transmission, multiple TRPs are associated with multiple precoding matrices, wherein each precoding matrix is assigned a given number of beams corresponding to spatial-domain basis vectors. Beams are allocated for each TRP based on two steps:
Step 1: Network configuration of a maximum number of beams per TRP, or a total maximum number of beams across TRPs; and
Step 2: UE determination of the exact number of beams per TRP, in addition to selection of the beam indices associated with this TRP.

One advantage of network-based selection of the beams corresponding to the PMI codebook is the efficient matching between resources allocated for CSI report over UCI and CSI report size. On the other hand, the UE-based selection of beams corresponding to the PMI codebook provides better performance since the selection is based on the channel conditions, which is available with high precision at the UE side, especially at low speeds. In the present disclosure, different solutions are proposed in which the network and UE cooperate for per TRP beam selection to ensure that the overall resources are utilized. In particular, the cooperative approach avoids the drawback for network-based selection of the beams corresponding to the PMI codebook. Although efficient matching between resources corresponding to UCI and CSI report size is provided by network-based selection, suboptimal performance occurs since the beam selection is not based on instantaneous channel conditions. Instead, with UE-based selection of the beams corresponding to the PMI codebook, better performance is provided since the beam selection is based on instantaneous channel conditions. However, the present disclosure recognizes that the UE-based selection may result in a mismatch between pre-determined resources corresponding to UCI and channel-based CSI report size. The UE may utilize the available uplink resources inefficiently. The present disclosure provides for adjustments to avoid these inefficiencies.

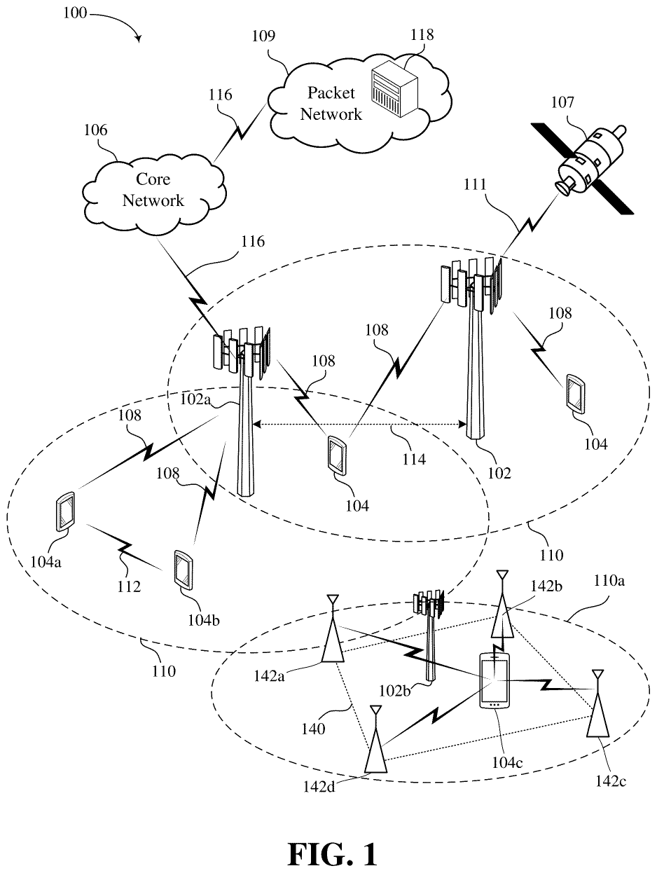

FIG. 1 illustrates an example of a wireless communications system 100 enabling efficient control signaling for channel state information (CSI) with collaboration by a network device and the user device including adjustment of CSI reporting to match uplink resources, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption adaptation protocol (SDAP), Packet Data Convergence Protocol (PDCP). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz 300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For increasing the reliability using multiple-point transmission, ultra-reliable low-latency communication (URLLC) under multiple-point transmission is planned for implementation. According to aspects of the present disclosure, the wireless communications system 100 includes one or more geographical coverage areas 110a that include a coordination cluster 140 for multi-point transmission of coordinated network devices 142a, 142b, 142c and 142d. For clarity, four coordinated network devices 142a-142d are depicted but a set of coordinated network devices can include fewer than four or more than four coordinated network devices 142a-142d. The coordinated network devices 142a-142d are capable of transmitting CSI reference signals (RS) 144 to UE 104c in simultaneous transmissions as well as other downlink control and data channels. The network devices 142a-142d may also be capable of receiving CSI reports from UE 104c as well as other uplink control and data channels. The coordinated network devices 142a-142d may not be co-located with each other and may include or augment a network device 102b that is responsible for scheduling UEs 104 for at least certain portions of the geographical coverage area 110a for one or more radio access technologies (RATs). Network device 102b may include one or more central processing units (CPUs) that supervise the coordinated network devices 142a-142d. The coordinated network devices 142a-142d may be base stations, network nodes, antenna panels, remote radio heads (RHHs), etc. Noting the respective remote locations, coordinated network devices 142a-142d may be referred to as TRPs. In general, the presence of K TRPs can trigger up to 2^{K}−1 possible transmission hypotheses. For instance, at K=4, the following 15 transmission hypotheses are possible:
4 single-TRP transmission hypotheses for TRPs 1,2,3,4;
6 double-TRP transmission hypotheses for TRP pairs {1,2}, {1,3}, {1,4}, {2,3}, {2,4}, {3,4};
4 triple-TRP transmission hypotheses for TRP triplets {1,2,3}, {1,2,4}, {1,3,4}, {2,3,4}; and
1 quadruple TRP hypothesis for TRP quadruplet {1,2,3,4}.

According to one or more aspects of the present disclosure, a device and method are provided to enable the continued collaboration between network and user device in control signaling for CSI reporting for multiple-point transmission, yet efficiently using the uplink resources. For a system with N_{TRP} TRPs, the network configures the UE with a set of N_{L} combinations of values for {L1, . . . , L_{NTRP}} each, wherein Ln corresponds to the number of beams associated with TRP n, and wherein the configuration is based on a higher layer signaling. The UE reports an indicator of size ┌log N_{L}┐ bits in Part 1 of the CSI report to indicate the selected number of beams.

In a first implementation or solution, each combination of values is reported without ordering, i.e., a configuration corresponding to beam values {a,b,c} also implies the support of {a,c,b}, {b,a,c}, {b,c,a}, {c,a,b}, and {c,b,a}. An indicator of size ┌log n!┐ bits is reported in Part 2 of the CSI report to identify the appropriate ordering.

In a second implementation or solution, the UE first selects N out of the N_{TRP} TRPs, wherein N≤N_{TRP}. If N<N_{TRP}, and L_{n′} corresponding to an unselected TRP n′ is larger than Lₙ corresponding to a selected TRP n, i.e., Lₙ<L_{n′}, the UE replaces Lₙ with L_{n′}.

In a third implementation or solution, the UE first selects N out of the N_{TRP} TRPs, wherein N≤N_{TRP}. If N<N_{TRP}, the constraint {L1, . . . , L_{NTRP}} is transformed into a constraint on a sum of the beams corresponding to the N selected TRPs, i.e., a new constraint

$${\sum }_{n = 1}^{N} {L}_{n} \leq {L}_{tot}$$

is applied, wherein

$${L}_{tot} = {\sum }_{n = 1}^{{N}_{TRP}} {L}_{n} .$$

The UE then reports the values L1, . . . , Lₙ in Part 2 of the CSI report, based on the aforementioned constraint on the sum of the beams. Several implementations and examples are provided below to explain the proposals and clarify how the present disclosure is implemented in practical scenarios.

In one or more embodiments, the present disclosure utilizes new radio (NR) codebook types, similar to NR Release 15 Type-II Codebooks as modified to incorporate the present disclosure. Assume the gNB is equipped with a two-dimensional (2D) antenna array with N₁, N₂ antenna ports per polarization placed horizontally and vertically and communication occurs over N₃ PMI sub-bands. A PMI subband consists of a set of resource blocks, each resource block consisting of a set of subcarriers. In such case, 2N₁N₂ CSI-RS ports are utilized to enable downlink (DL) channel estimation with high resolution for NR Rel. 15 Type-II codebook. In order to reduce the UL feedback overhead, a Discrete Fourier transform (DFT)-based CSI compression of the spatial domain is applied to L dimensions per polarization, where L<N₁N₂. In the sequel the indices of the 2L dimensions are referred as the Spatial Domain (SD) basis indices. The amplitude and phase values of the linear combination coefficients for each sub-band are fed back to the gNB as part of the CSI report. The 2N₁N₂×N₃ codebook per layer/takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${ν}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{ν}_{{l}_{0} , {m}_{0}} & {ν}_{{l}_{1} , {m}_{1}} & … & {ν}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{2,1} is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,1} are independent for different layers.

In one or more embodiments, the present disclosure utilizes new radio (NR) codebook types, similar to NR Release 15 Type-II Port Selection Codebook as modified to incorporate the present disclosure. For Type-II Port Selection codebook, only K (where K≤2N₁N₂) beamformed CSI-RS ports are utilized in DL transmission, in order to reduce complexity. The. The K×N₃ codebook matrix per layer takes on the form:

$${W}_{l} = {W}_{1}^{PS} {W}_{2 , l} .$$

Here, W₂ follow the same structure as the conventional NR Rel. 15 Type-II Codebook and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows,

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2 )}^{( K / 2 )} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas mps takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to mps={0,1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \text{} \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to mps={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=3, the 3 possible realizations of E corresponding of mps={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of mps={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ]$$

To summarize, mps parametrizes the location of the first 1 in the first column of E, whereas d_{PS} represents the row shift corresponding to different values of mps.

Aspects of the present disclosure may incorporate features of NR Rel. 15 Type-I codebook, which is the baseline codebook for NR, with a variety of configurations. The most common utility of Rel. 15 Type-I codebook is a special case of NR Rel. 15 Type-II codebook with L=1 for RI=1, 2, wherein a phase coupling value is reported for each sub-band, i.e., W_{2,1} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁= . . . =φ_{N}_{₃}₋₁, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

Aspects of the present disclosure may incorporate features of NR Rel. 15 Type-II codebook. Assume the gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the uplink (UL) feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the amplitude and phase values of a subset of the delay-domain coefficients are selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , {l}_{i} = {O}_{1} {n}_{1}^{( i )} + {q}_{1} , 0 \leq {n}_{1}^{( i )} < {N}_{1} , 0 \leq {q}_{1} < {O}_{1} , {m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f,l} is an N₃×M matrix (M<N₃) with columns selected from a critically sampled size-N₃ DFT matrix, as follows:

$${w}_{f , l} = [ \begin{matrix}{f}_{{k}_{0}} & {f}_{{k}_{1}} & … & {f}_{{k}_{M - 1}}\end{matrix} ] , 0 \leq {k}_{i} \leq {N}_{3} - 1 , \\ {f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, and W_{f,l} are selected independently for different layers. Amplitude and phase values of an approximately β fraction of the 2 LM available coefficients are reported to the gNB (β<1) as part of the CSI report. Note that coefficients with zero amplitude values are indicated via a layer-specific bitmap matrix Sₗ of size 2L×M, wherein each bit of the bitmap matrix Sₗ indicates whether a coefficient has a zero-amplitude value, wherein for these coefficients no quantized amplitude and phase values need to be reported. Since all non-zero coefficients reported within a layer are normalized with respect to the coefficient with the largest amplitude value (strongest coefficient), wherein the amplitude and phase values corresponding to the strongest coefficient are set to one and zero, respectively, and hence no further amplitude and phase information is explicitly reported for this coefficient, and only an indication of the index of the strongest coefficient per layer is reported. Hence, for a single-layer transmission, amplitude, and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

Aspects of the present disclosure may incorporate features of NR Rel. 16 Type-II Port Selection Codebook. For Type-II Port Selection codebook, only K (where K≤2N₁N₂) beamformed CSI-RS ports are utilized in DL transmission, in order to reduce complexity. The. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,1} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

Aspects of the present disclosure may incorporate features of NR Rel. 17 Type-II Port Selection Codebook. Rel. 17 Type-II Port Selection codebook follows a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,1} and W_{f,l} follow the same structure as the conventional NR Rel. 16 Type-II Codebook, however M is limited to 1, 2 only, with the network configuring a window of size N={2,4} for M=2. Moreover, the bitmap is reported unless=1 and the UE reports all the coefficients for a rank up to a value of two.

Aspects of the present disclosure may incorporate features of NR Rel. 18 Type-II Codebook. For Rel-18 potential Type-II codebook, the time-domain corresponding to slots is further compressed via DFT-based transformation, wherein the codebook is in the following form

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically sampled size-N₄ DFT matrix, as follows

$${W}_{d , l} = [ {d}_{{q}_{0}} {d}_{{q}_{1}} ⋯ {d}_{{q}_{Q - 1}} ] , 0 \leq {q}_{i} \leq {N}_{4} - 1 ,$$

$${d}_{q} = {[ 1 {e}^{- j \frac{2 π q}{{N}_{4}}} ⋯ {e}^{- j \frac{2 π q ( {N}_{4} - 1 )}{{N}_{4}}} ]}^{T} .$$

Only the indices of the Q selected columns of W_{d,l} are reported. Note that W_{d,1} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,1} is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with Rel-18 Type-II codebook.

Aspects of the present disclosure may incorporate features of Codebook Reporting. The codebook report is partitioned into two parts based on the priority of information reported. Each part is encoded separately wherein Part 1 has a possibly higher code rate. Below the parameters for NR Rel. 16 Type-II codebook only are listed. The following is an example of content of CSI report:
Part 1: RI+CQI+Total number of coefficients
Part 2: SD basis indicator+FD basis indicator/layer+Bitmap/layer+Coefficient Amplitude info/layer+Coefficient Phase info/layer+Strongest coefficient indicator/layer.
   Furthermore, Part 2 CSI can be decomposed into sub-parts each with different priority (higher priority information listed first). Such partitioning is required to allow dynamic reporting size for codebook based on available resources in the uplink phase. Also Type-II codebook is based on aperiodic CSI reporting, and only reported in PUSCH via DCI triggering (one exception). Type-I codebook can be based on periodic CSI reporting (PUCCH) or semi-persistent CSI reporting (PUSCH or PUCCH) or aperiodic reporting (PUSCH).

Priority reporting for Part 2 CSI: Note that multiple CSI reports may be transmitted with different priorities, as shown in TABLE 1. Additionally, the priority of the N_{Rep} CSI reports is based on the following
A CSI report corresponding to one CSI reporting configuration for one cell may have higher priority compared with another CSI report corresponding to one other CSI reporting configuration for the same cell
CSI reports intended to one cell may have higher priority compared with other CSI reports intended to another cell
CSI reports may have higher priority based on the CSI report content, e.g., CSI reports carrying L1-RSRP information have higher priority
CSI reports may have higher priority based on their type, e.g., whether the CSI report is aperiodic, semi-persistent or periodic, and whether the report is sent via PUSCH or PUCCH, may impact the priority of the CSI report

In light of that, CSI reports may be prioritized as follows, where CSI reports with lower IDs have higher priority

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI:

Priority 0: For CSI reports 1 to N_Rep, Group 0 CSI for CSI reports
configured as ‘typeII-r16’ or ‘typeII-PortSelection-r16’; Part 2
wideband CSI for CSI reports configured otherwise.
Priority 1: Group 1 CSI for CSI report 1, if configured as ‘typeII-r16’ or
‘typeII-PortSelection-r16’; Part 2 subband CSI of even subbands for
CSI report 1, if configured otherwise.
Priority 2: Group 2 CSI for CSI report 1, if configured as ‘typeII-r16’ or
‘typeII-PortSelection-r16’; Part 2 subband CSI of odd subbands for
CSI report 1, if configured otherwise.
Priority 3: Group 1 CSI for CSI report 2, if configured as ‘typeII-r16’ or
‘typeII-PortSelection-r16’; Part 2 subband CSI of even subbands for
CSI report 2, if configured otherwise.
Priority 4: Group 2 CSI for CSI report 2, if configured as ‘typeII-r16’ or
‘typeII-PortSelection-r16’. Part 2 subband CSI of odd subbands for
CSI report 2, if configured otherwise:
Priority 2N_Rep-1: Group 1 CSI for CSI report N_Rep, if configured as
‘typeII-r16’ or ‘typeII-PortSelection-r16’; Part 2 subband
CSI of even subbands for CSI report N_Rep, if configured otherwise.
Priority 2N_Rep: Group 2 CSI for CSI report N_Rep, if configured as
‘typeII-r16’ or ‘typeII-PortSelection-r16’; Part 2 subband
CSI of odd subbands for CSI report N_Rep, if configured otherwise.

Triggering aperiodic CSI reporting on PUSCH: UE needs to report the needed CSI information for the network using the CSI framework in NR Release 15. The triggering mechanism between a report setting and a resource setting can be summarized in Table 2:

TABLE 2

| | | Periodic CSI | | AP CSI |
|---|---|---|---|---|
| | | reporting | SP CSI reporting | Reporting |
| Time | Periodic | RRC | MAC CE (PUCCH) | DCI |
| Domain | CSI-RS | configured | DCI (PUSCH) | |
| Behavior of | SP CSI-RS | Not | MAC CE (PUCCH) | DCI |
| Resource | | Supported | DCI (PUSCH) | |
| Setting | AP CSI-RS | Not | Not Supported | DCI |
| | | Supported | | |

Moreover, note the following:
All associated Resource Settings for a CSI Report Setting need to have same time domain behavior;
Periodic CSI-RS/IM resources and CSI reports are always assumed to be present and active once configured by RRC;
Aperiodic and semi-persistent CSI-RS/IM resources and CSI reports need to be explicitly triggered or activated;
Aperiodic CSI-RS/IM resources and aperiodic CSI reports, the triggering is done jointly by transmitting a DCI Format 0-1; and
Semi-persistent CSI-RS/IM resources and semi-persistent CSI reports are independently activated.

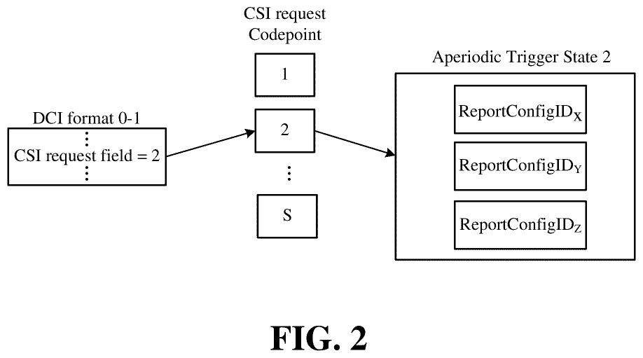

FIG. 2 is a diagram of aperiodic trigger state defining a list of CSI report settings. For aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

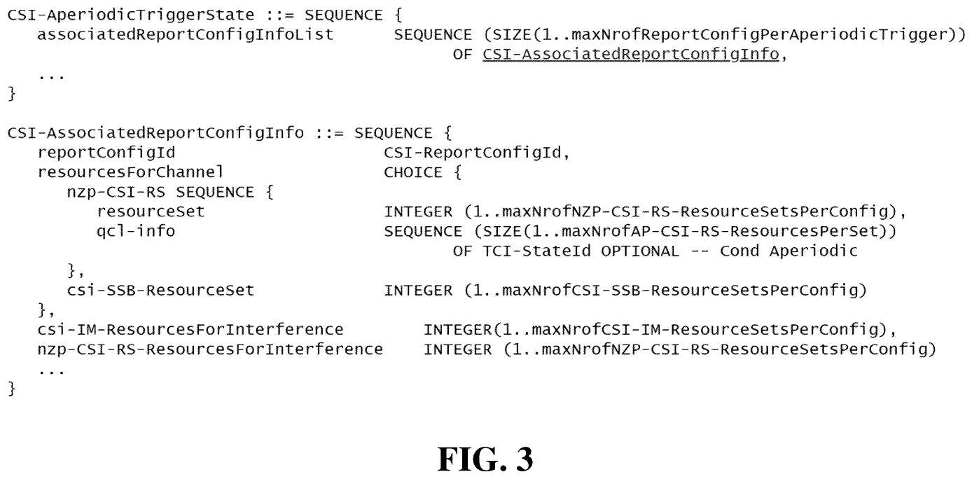

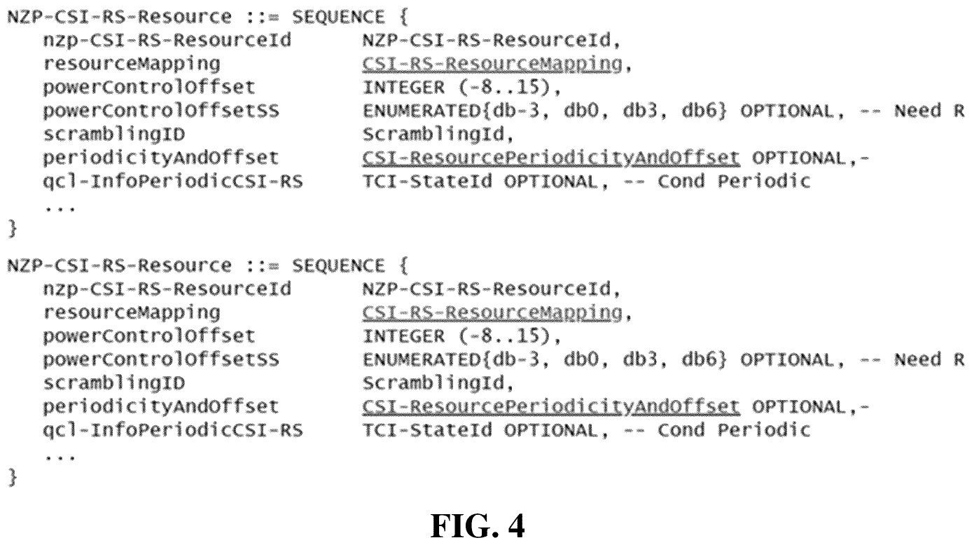

FIG. 3 is example program code for aperiodic trigger that indicates the resource set and quasi co-located (QCL) information. When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE assumes that the resources used for the computation of the channel and interference can be processed with the same spatial filter i.e., quasi-co-located with respect to “QCL-TypeD.” FIG. 4 describes the RRC configuration for NZP-CSI-RS/CSI-IM resources. Table 3 summarizes the type of uplink channels used for CSI reporting as a function of the CSI codebook type.

TABLE 3

| | Periodic CSI | | AP CSI |
|---|---|---|---|
| | reporting | SP CSI reporting | reporting |
| Type I WB | PUCCH | PUCCH Format 2 | PUSCH |
| | Format 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead. CSI Part 1 has a fixed payload size (and can be decoded by the gNB without prior information) and contains the following: (i) rank indicator (RI) (if reported), CSI-RS resource index (CRI) (if reported) and channel quality indicator (CQI) for the first codeword, and (ii) number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4.

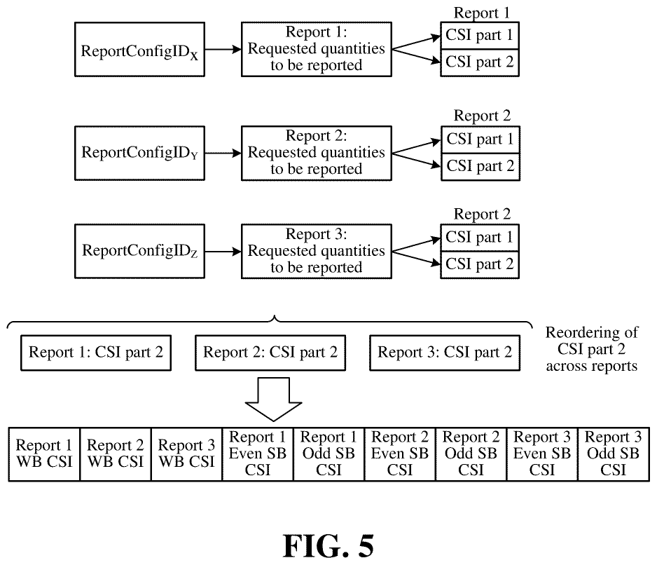

FIG. 5 is a diagram of partial CSI omission for Rel. 15 PUSCH-based CSI. For example, if the aperiodic trigger state indicated by DCI format 0_1 defines 3 report settings x, y, and z, then the aperiodic CSI reporting for CSI part 2 will be ordered as indicated. As mentioned earlier, CSI reports are prioritized according to: (i) time-domain behavior and physical channel, where more dynamic reports are given precedence over less dynamic reports and PUSCH has precedence over PUCCH; (ii) CSI content, where beam reports (i.e., layer 1 reference signal received power (L1-RSRP) reporting) has priority over regular CSI reports; (iii) the serving cell to which the CSI corresponds (in case of carrier aggregation (CA) operation). CSI corresponding to the primary cell (PCell) has priority over CSI corresponding to Scells; and (iv) the report configuration identifier (“reportConfigID”).

CQI reporting: A CSI report may comprise a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate and efficiency is provided in Table 4.

TABLE 4

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each physical downlink shared channel (PDSCH) transport block, and a subband format, wherein one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5.

TABLE 5

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, i.e., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

Sub-band Offset level(s)=sub-band CQI index(s)−wideband CQI index.

The mapping from the 2-bit sub-band differential CQI values to the offset level is shown in Table 6.

TABLE 6

| Sub-band differential CQI value | Offset level |
|---|---|
| 0 | 0 |
| 1 | 1 |
| 2 | ≥2 |
| 3 | ≤−1 |

Antenna Panel/Port, Quasi co-location, TCI state, Spatial Relation: In some implementations, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi co-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receiver (RX) beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a Transmission Configuration Indication (TCI) state associated with a target transmission can indicate parameters for configuring a quasi co-location relationship between the target transmission (e.g., target RS of demodulation reference signal (DM-RS) ports of the target transmission during a transmission occasion) and a source reference signal(s) with respect to quasi co-location type parameter(s) indicated in the corresponding TCI state. Examples of source reference signal(s) include synchronization signal block (SSB), CSI-RS, and sounding reference signal (SRS). The TCI describes which reference signals are used as QCL source, and what QCL properties can be derived from each reference signal. A device can receive a configuration of a plurality of transmission configuration indicator states for a serving cell (SCell) for transmissions on the SCell. In some of the implementations described, a TCI state comprises at least one source RS to provide a reference (UE assumption) for determining QCL and/or spatial filter.

In some of the implementations described, a spatial relation information associated with a target transmission can indicate parameters for configuring a spatial setting between the target transmission and a reference signal (RS) (e.g., SSB/CSI-RS/SRS). For example, the device may transmit the target transmission with the same spatial domain filter used for reception of the RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a SCell for transmissions on the SCell.

In some of the implementations described, a UL TCI state is provided if a device is configured with separate DL/UL TCI by radio resource control (RRC) signaling. The UL TCI state may comprise a source reference signal which provides a reference for determining UL spatial domain transmission filter for the UL transmission (e.g., dynamic-grant/configured-grant based physical uplink shared channel (PUSCH), dedicated physical uplink control channel (PUCCH) resources) in a component carrier (CC) or across a set of configured CCs and bandwidth parts (BWPs).

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Building upon the preceding discussion, the present disclosure provides proposed solutions for efficient use of uplink resources by the UE. Assume a channel between a UE and a gNB with P channel paths (index p=0, . . . , P−1) that occupies N_{SB} frequency bands (index n=0, . . . , N_{SB}−1), wherein the gNB is equipped with K antennas (index k=0, . . . , K−1). The channel at a time index & can then be represented as follows

$${h}_{k , n} ( δ ) = {\sum }_{p = 0}^{P - 1} {ℊ}_{k , p} {e}^{j 2 π n Δ f {τ}_{p} + j2πk \frac{{F}_{c} d}{c} s i n {θ}_{p} + j 2 π δ \frac{{F}_{c} v}{c} c o s {∅}_{p}}$$

g_{k,p}: Complex gain of path p at antenna k
Δf: PMI Sub-band spacing
τₚ: Delay of path p
F_{c}: Carrier Frequency
c: Speed of light
d: Antenna spacing at gNB
θₚ: angular spatial displacement at the gNB antenna array corresponding to path p
δ: Time index
v: Relative speed between gNB & UE
Φₚ: Angle between the moving direction & the signal incidence direction of path p

CSI Reporting Configuration Indication for joint transmission: A UE is configured by higher layers with one or more CSI-ReportConfig Reporting Settings for CSI reporting, one or more CSI-ResourceConfig Resource Settings for CSI measurement, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList may contain a list of a subset of the associated CSI-ReportConfigs indicating the Resource Set IDs for channel and optionally for interference. Each trigger state in CSI-SemiPersistentOnPUSCH-TriggerStateList may contain one or more associated CSI-ReportConfig. Different embodiments for indication of multi-TRP transmission are provided below. Considering a setup with a combination of one or more of the following embodiments is not precluded.

Different embodiments for indication of joint transmission from multiple network nodes are provided below. Considering a setup with a combination of one or more of the following embodiments is not precluded.

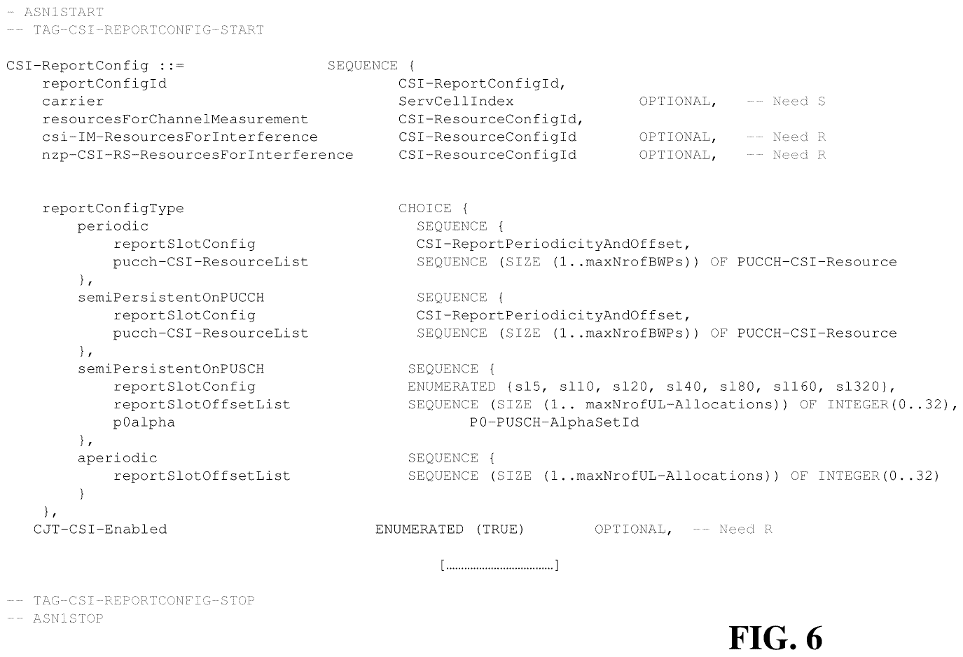

FIG. 6 is an example of a first embodiment of abstract syntax notation one (ASN.1) code for CSI-ReportConfig Reporting Setting IE with multi-TRP transmission indication. In the first embodiment, a UE configured with joint transmission may be configured with a CSI Reporting Setting CSI-ReportConfig, that includes a higher-layer parameter, e.g., CJT-CSI-Enabled, that configures the UE with multi-TRP transmission, e.g., CJT. An example of the ASN.1 code that corresponds to such CSI-ReportConfig Reporting Setting IE is provided in FIG. 6 with a higher-layer parameter that triggers multi-TRP based CSI reporting.

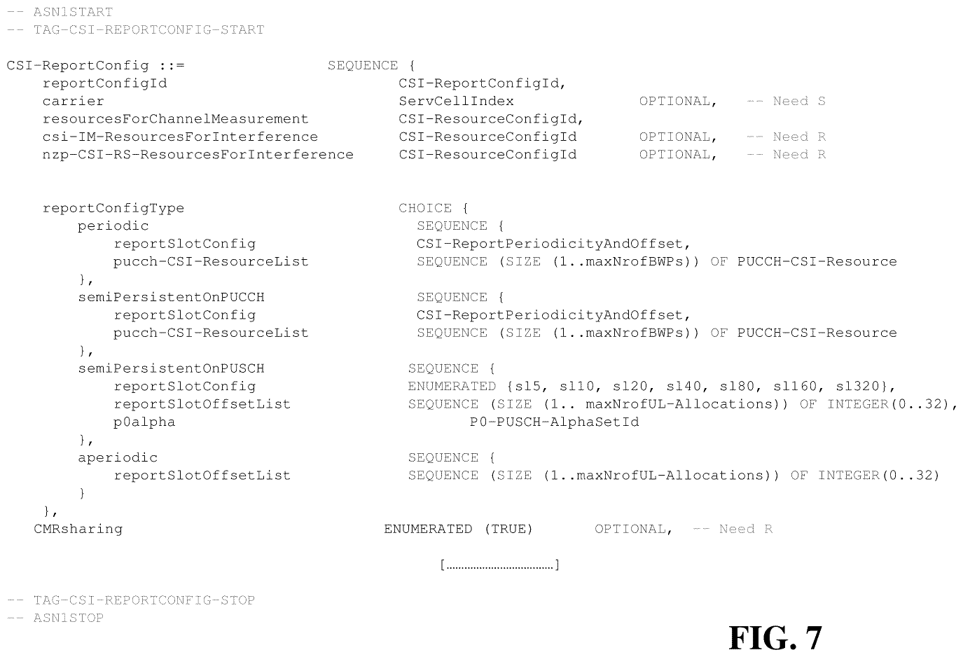

FIG. 7 is an example of a second embodiment of ASN.1 code for CSI-ReportConfig Reporting Setting IE with multi-TRP transmission indication. In the second embodiment, a UE configured with joint transmission may be configured with a CSI Reporting Setting CSI-ReportConfig, that includes a higher-layer parameter, e.g., CMRsharing, that configures the UE with joint transmission with shared CMRs for single-TRP and multi-TRP transmission hypotheses. An example of the ASN.1 code that corresponds to such CSI-ReportConfig Reporting Setting IE is provided in FIG. 7 with a higher-layer parameter that triggers multi-TRP based CSI reporting.

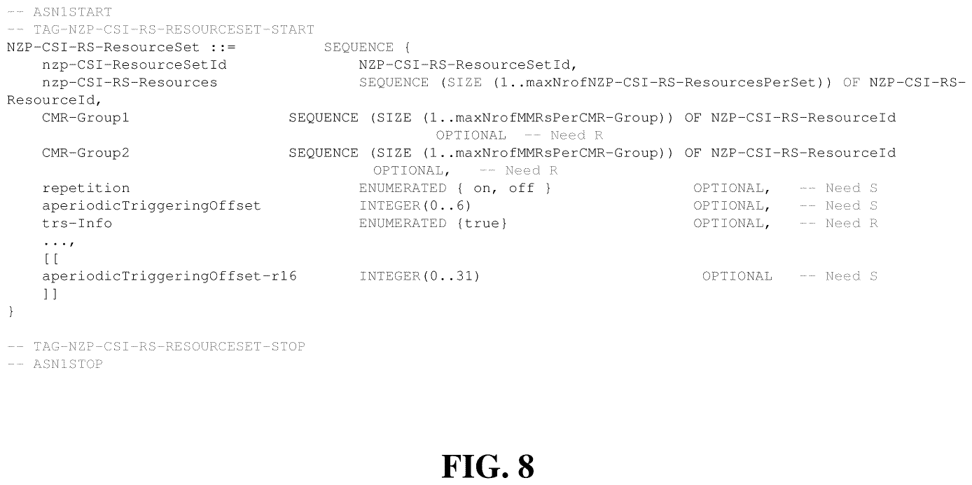

FIG. 8 is an example of a third embodiment of ASN.1 code for triggering more than one CMR group in an NZP CSI-RS Resource Set Configuration IE. In the third embodiment, a UE configured with joint transmission may be configured with a CSI Reporting Setting, CSI-ReportConfig, that includes a higher-layer parameter which triggers two groups of CMRs, i.e., two groups of NZP CSI-RS resources for channel measurement, e.g., CMR-Group1, CMR-Group2, corresponding to the two TRPs. In one example, the higher-layer parameter exists in an IE within the CSI Reporting Setting, e.g., an NZP CSI-RS Resource Set Configuration, NZP-CSI-RS-ResourceSet, that is configured for channel measurement. An example of the ASN.1 code the corresponds to this IE is provided in FIG. 8.

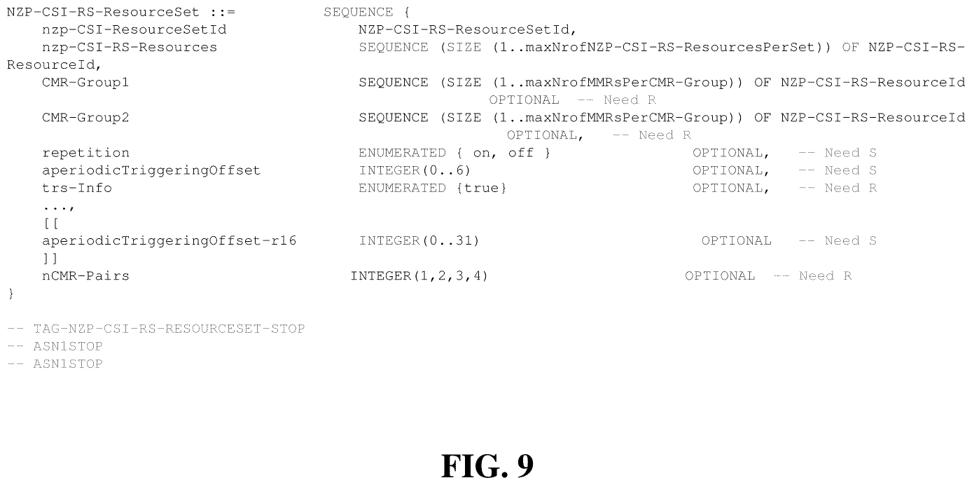

FIG. 9 is an example of a fourth embodiment of ASN.1 code for triggering two CSI Reports within CodebookConfig Codebook Configuration IE. In the fourth embodiment, a UE configured with joint transmission may be configured with a CSI Reporting Setting, CSI-ReportConfig, that includes a higher-layer parameter which triggers a set of N CMR pairs, corresponding to CMRs associated with joint transmission from the two TRPs, e.g., nCMR-Pairs, corresponding to the two TRPs. In one example, the higher-layer parameter exists in an IE within the CSI Reporting Setting, e.g., an NZP CSI-RS Resource Set Configuration, NZP-CSI-RS-ResourceSet, that is configured for channel measurement. An example of the ASN.1 code the corresponds to this IE is provided in FIG. 9.

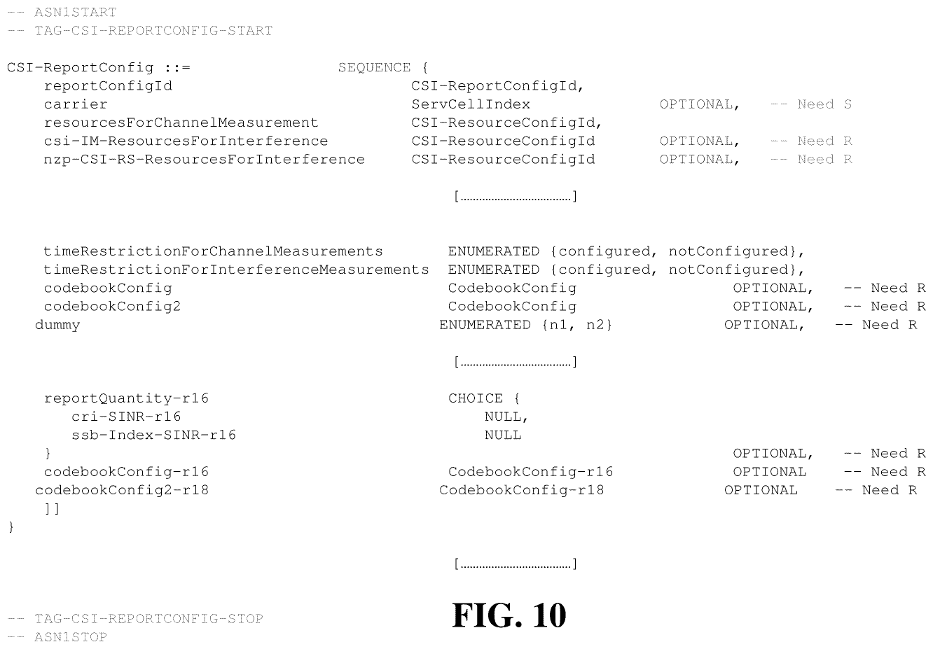

FIG. 10 is an example of a fifth embodiment of ASN.1 code for triggering two CSI Reports within CSI-ReportConfig Reporting Setting IE. In the fifth embodiment, a UE configured with joint transmission may be configured with one or more CSI Reporting Settings CSI-ReportConfig, wherein at least one of the one or more CSI Reporting Settings CSI-ReportConfig configures two CodebookConfig codebook configurations corresponding to one or more CSI Reports. An example of the ASN.1 code the corresponds to the CSI-ReportConfig Reporting Setting IE is provided in FIG. 10, wherein two codebook configurations are triggered under the same Reporting Setting.

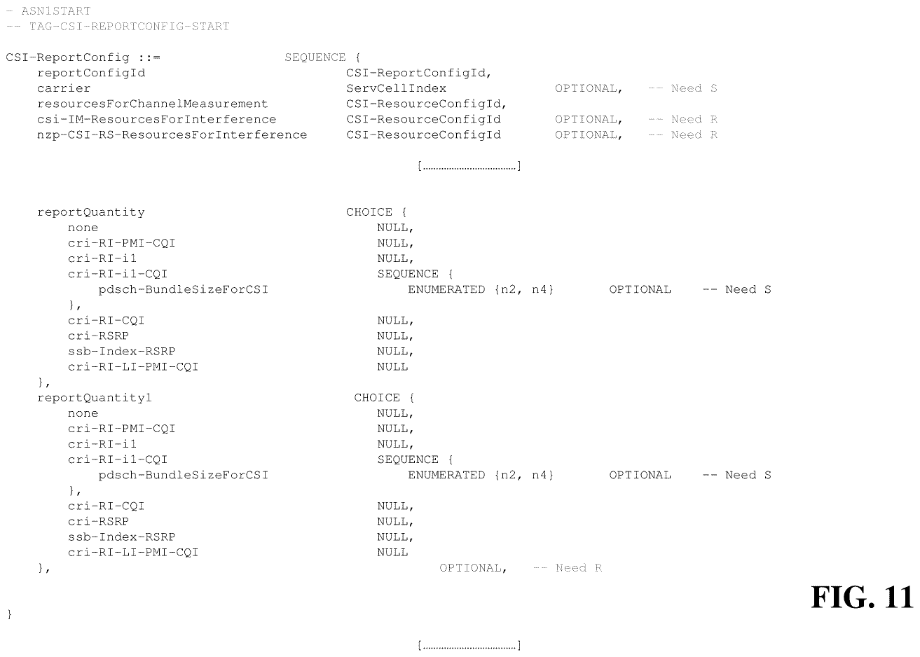

FIG. 11 is an example of a sixth embodiment of ASN.1 code for triggering two CSI Reports within CSI-ReportConfig Reporting Setting IE. In the sixth embodiment, a UE configured with joint transmission may be configured with one or more CSI Reporting Settings CSI-ReportConfig, wherein at least one of the one or more CSI Reporting Settings CSI-ReportConfig configures two reportQuantity Report Quantities corresponding to one or more CSI Reports. An example of the ASN.1 code the corresponds to the CSI-ReportConfig Reporting Setting IE is provided in FIG. 11.

In a seventh embodiment, joint transmission may correspond to a transmission scheme comprising a PDSCH codeword transmitted from more than one TRP. In a first example, the PDSCH codeword is associated with more than one TCI state. In a second example, a first set of DMRS ports for PDSCH are associated with a TCI state with a first NZP CSI-RS resource, and a second set of DMRS ports for PDSCH are associated with a TCI state with a second NZP CSI-RS resource.

Multiple transmission hypotheses configuration: In a first implementation, a UE configured with CSI reporting under joint transmission is further configured with a CSI reporting setting, wherein the CSI reporting setting indicates a group of CMRs corresponding to a group of NZP CSI-RS resources, a size of the group of the CMRs is N_{TRP}. In a first example, the size of the group of the CMRs N_{TRP} takes on one of values {2,3,4}. In a second example, each CMR of the group of the CMRs corresponds to a distinct TRP, panel, BS, gNB, or some combination thereof. In a third example, the group of the NZP CSI-RS resources are associated with a same NZP CSI-RS resource set.

In a second implementation, a UE configured with CSI reporting under joint transmission is further configured with feeding back a CSI report, the CSI report comprises two parts, and wherein a first part of the two parts of the CSI report comprises a selection of a subset of the CMRs, a size of the subset of the CMRs is N. In a first example, the size of the subset of the CMRs N takes on one of values {1,2,3,4}. In a second example, the size of the subset of the CMRs is no larger than the size of the group of the CMRs, i.e., N≤N_{TRP}. Table 7 is an example of a bitmap with N_{TRP}=4, N=2, wherein the second and third CMRs are selected. In a third example, the selection of the subset of the CMRs is in a form of a bitmap vector of a length equal to the size of the group of the CMRs, N_{TRP}, and wherein a number of entries with a value one in the bitmap vector is equal to the size of the subset of the CMRs, N. An example of a bitmap with N_{TRP}=4, N=2, wherein the second and third CMRs are selected, is provided in Table 7:

TABLE 7

| | | | |
|---|---|---|---|
| 0 | 1 | 1 | 1 |

Table 8 is an example of values of

$${C}_{x}^{y}$$

for all x, y values from a set of {1,2,3,4}. In a fourth example, the selection of the subset of the CMRs is in a form of a combinatorial value, the combinatorial value is reported in a form of a parameter comprising

$$⌈ {log}_{2} {C}_{N}^{{N}_{T R P}} ⌉$$

bits, wherein log₂ operator corresponds to a logarithmic function of base two, an output of a function ┌x┐, i.e., ceiling function, is a smallest integer value that is no smaller than a real number x, and

$${C}_{x}^{y}$$

cates all possible unordered selections of x units out of a set of y units, wherein x≤y. A table of values of

$${C}_{x}^{y}$$

is shown in Table 8:

TABLE 8

| y/x | x = | x = | x = | x = |
|---|---|---|---|---|
| values | 1 | 2 | 3 | 4 |
| y = 1 | 1 | | | |
| y = 2 | 2 | 1 | | |
| y = 3 | 3 | 3 | 1 | |
| y = 4 | 4 | 6 | 4 | 1 |

In a third implementation, a UE configured with CSI reporting under joint transmission is further configured with a CSI reporting setting, wherein the CSI reporting setting includes a parameter that indicates a set of number-of-beam combinations, each number-of-beam combination comprises a number of beams corresponding to each CMR of the N_{TRP} configured CMRs. A UE indicates a selected number-of-beam combination from the set of number-of-beam combinations, wherein an indication of an index of the selected number-of-beam combination is reported in the CSI report. In a first example, a size of the set of the number of beam combinations is N_{L}, wherein N_{L}≥1. In a second example, a codebook of values corresponding to the number of beams for each CMR comprises values {2,4,6}. In a third example, each number-of-beam combination of the set of number-of-beam combinations comprises N_{TRP} values, each value of the N_{TRP} values is drawn from the codebook of values corresponding to the number of beams for each CMR. In a fourth example, the indication of the index of the selected number-of-beam combination is reported in a first part of two parts of the CSI report.

Configuration and selection of unordered number of beam combinations: In a first implementation, a beam combination comprising N_{TRP} values corresponding to the N_{TRP} CMRs is unordered, i.e., any permutation of the N_{TRP} values is supported. In a first example, for a configured number-of-beam combination of values {L₁, L₂, L₃} for N_{TRP}=3, all remaining combinations {L₁, L₃, L₂}, {L₂, L₁, L₃}, {L₂, L₃, L₁}, {L₃, L₁, L₂}, and {L₃, L₂, L₁} are also configured.

In a second implementation, the UE reports a first indication of a selection of an unordered number-of-beam combination, and a second indication of an ordering of the number-of-beam combination. In a first example, the first indication and the second indication are jointly encoded into one parameter reported in a first part of two parts of the CSI report. In a second example, each of the first indication and the second indication are encoded separately into two parameters reported in the CSI report, wherein a first of the two parameters corresponding to the first indication is reported in a first part of two parts of the CSI report, and a second of the two parameters corresponding to the second indication is reported in a second part of the two parts of the CSI report.

Table 9 is an example of values of x! for all x values corresponding to a set of {1,2,3,4}. In a third example, a bitwidth of a parameter corresponding to the second indication of the ordering of the number-of-beam combination is ┌log₂ N_{TRP}!┐ bits, wherein an operator x! corresponds to a factorial value of a parameter x. An example of the corresponding values is provided in Table 9:

TABLE 9

| | | | | |
|---|---|---|---|---|
| x | 1 | 2 | 3 | 4 |
| x! | 1 | 2 | 6 | 24 |
| [log₂ x!] | 0 | 1 | 3 | 5 |

In a third implementation, the second indication corresponds to an ordered sub-selection of the number-of-beam combination, wherein a size of the sub-selection is N.

Table 10 is an example of values of

$${P}_{x}^{y}$$

for all x, y values from a set of {1,2,3,4}. In a first example, a bitwidth of a parameter corresponding to the second indication of the ordered sub-selection of the number-of-beam combination

$$⌈ {log}_{2} {P}_{N}^{{N}_{T R P}} ⌉$$

pits, wherein

$${P}_{x}^{y}$$

is a combinatorial value that indicates all possible ordered selections of x units out of a set of y units, wherein x≤y. A table of values of

$${P}_{x}^{y}$$

is shown in Table 10:

TABLE 10

| y/x | | | | |
|---|---|---|---|---|
| values | x = 1 | x = 2 | x = 3 | x = 4 |
| y = 1 | 1 | | | |
| y = 2 | 2 | 2 | | |
| y = 3 | 3 | 6 | 6 | |
| y = 4 | 4 | 12 | 24 | 24 |

Configuration and selection of a subset of number of beam combinations: In a first implementation, the selection of a subset of the CMRs is of a size N, wherein the subset of the CMRs is smaller than the group of the CMRs of size N, i.e., N<N_{TRP}.

In a second implementation, a number of beams associated with a selected CMR is replaced with a number of beams of the selected number-of-beam-combination that is associated with a CMR that is not selected. In a first example, N_{TRP}=3, N=2, the selection of the subset of the CMRs is [1 1 0], i.e., the first and the second CMRs are selected, and the selected number-of-beam combination is [4 2 6]. Since a number of beams associated with the third CMR is larger than a number of beams associated with the second CMR, and since the second CMR is selected and the third CMR is not selected, the number of beams associated with the second CMR is substituted with the number of beams associated with the third CMR, i.e., the number of beams associated with the selected second CMR is 6. In a second example, if a maximum value of a number of beams associated with unselected CMRs is larger than a minimum value of a number of beams associated with selected CMRs, the minimum value of the number of beams associated with the selected CMRs is substituted by the maximum value of the number of beams associated with the unselected CMR

In a third implementation, a constraint value, Lₜₒₜ, based on a sum of a number of beams of the selected number-of-beam combination is derived, and wherein a sum of a number of beams associated with the subset of the CMRs is no larger than the constraint value Lₜₒₜ. In a first example, N_{TRP}=4, N=2, the selection of the subset of the CMRs is [0 1 1 0], i.e., the second and third CMRs are selected, and the selected number-of-beam combination is [4 2 2 6], and hence the constraint value is Lₜₒₜ=4+2+2+6=14. A sum of a number of beams associated with the selected second and third CMRs is no larger than Lₜₒₜ=14. In a second example, a number of beams associated with each CMR is selected from a number-of-beams codebook, wherein the number-of-beams codebook for each CMR comprises values {2,4,6}

In the present disclosure, a CSI feedback mechanism is proposed that aims at efficient selection of the number of beams associated with a PMI codebook in a joint transmission scenario. More specifically, the following is proposed:

For a system with N_{TRP} TRPs, the network configures the UE with a set of N_{L} combinations of values for {L₁, . . . , L_{NTRP}} each, wherein Lₙ corresponds to the number of beams associated with TRP n, and wherein the configuration is based on a higher layer signaling. The UE reports an indicator of size ┌log N₂┐ bits in Part 1 of the CSI report to indicate the selected number of beams. In a first implementation, each combination of values is reported without ordering, i.e., a configuration corresponding to beam values {a,b,c} also implies the support of {a,c,b}, {b,a,c}, {b,c,a}, {c,a,b}, and {c,b,a}. An indicator of size ┌log n!┐ bits is reported in Part 2 of the CSI report to identify the appropriate ordering. In a second implementation, the UE first selects N out of the N_{TRP} TRPs, wherein N≤N_{TRP}. If N<N_{TRP}, and L_{n′} corresponding to an unselected TRP n′ is larger than Lₙ corresponding to a selected TRP n, i.e., Lₙ<L_{n′}, the UE replaces Lₙ with L_{n′}. In a third implementation, the UE first selects N out of the N_{TRP} TRPs, wherein N≤N_{TRP}. If N<N_{TRP}, the constraint {L₁, . . . . L_{NTRP}} is transformed into a constraint on a sum of the beams corresponding to the N selected TRPs, i.e., a new constraint

$${Σ}_{n = 1}^{N} {L}_{n} \leq {L}_{tot}$$

is applied, wherein

$${L}_{tot} = {Σ}_{n = 1}^{{N}_{TRP}} {L}_{n} .$$

The UE then reports the values L₁, . . . , Lₙ in Part 2 of the CSI report, based on the aforementioned constraint on the sum of the beams.

According to aspects of the present disclosure, a method of a User Equipment (“UE”) is provided. In one or more embodiments, the method includes: receiving a Channel State Information (“CSI”) reporting setting that is associated with a Channel Measurement Resource (“CMR”) corresponding to a first set of CSI Reference Signal (“CSI-RS”) segments; further receiving a configuration corresponding to a plurality of beam combinations, each beam combination comprises a number of beams corresponding to each CSI-RS segment of the first set of CSI-RS segments; determining a second set of CSI-RS segments based on the first set of CSI-RS segments, wherein the second set of CSI-RS segments is a subset of or equal to the first set of CSI-RS segments; reporting a first indication of a selection of the second set of the CSI-RS segments, the first indication reported in a first part of two parts of a CSI report; further reporting a second indication corresponding to a selection of a beam combination based on the plurality of beam combinations, the second indication reported in the first part of the two parts of the CSI report. The method further includes: the UE adjusting the number of beams corresponding to each CSI-RS segment of the second set of CSI-RS segments based on the selection of the second set of the CSI-RS segments and the selection of the beam combination from the plurality of the beam combinations; generating a CSI report comprising a set of Precoding Matrix Indicator (“PMI”) segments, each PMI segment of the set of PMI segments is associated with a CSI-RS segment of the second set of CSI-RS segments; and transmitting the CSI report comprising the set of PMI segments.

In one or more embodiments, the first set of CSI-RS segments correspond to CSI-RS that is received under coherent joint transmission from a plurality of networks nodes, wherein each CSI-RS segment of the first set of CSI-RS segments corresponds to a different one of the plurality of nodes, and wherein the CSI report is transmitted to at least one network node of the plurality of network nodes, and wherein each network node of the plurality of network nodes is associated with a distinct TCI state of a Physical Downlink Shared Channel (PDSCH) transmission. In one or more embodiments, each of the CSI-RS segments of the first set of CSI-RS segments corresponds to a distinct non-zero power (“NZP”) CSI-RS resource.

In one or more embodiments, a first CSI-RS segment of the at least two CSI-RS segments correspond to a first subset of a set of CSI-RS ports of a non-zero power (“NZP”) CSI-RS resource, and wherein a second CSI-RS segment of the at least two CSI-RS segments correspond to a second subset of the set of CSI-RS ports of the NZP CSI-RS resource. In one or more particular embodiments, the first subset of the set of CSI-RS ports corresponds to a first code-division multiplexing (“CDM”) group, and the second subset of the set of CSI-RS ports corresponds to a second CDM group.

In one or more embodiments, each PMI segment of the set of PMI segments corresponds to a distinct PMI quantity. In one or more embodiments, each PMI segment of the set of PMI segments corresponds to a distinct set of non-zero power (“NZP”) CSI-RS ports of a same PMI quantity. In one or more embodiments, each PMI segment of the set of PMI segments corresponds to a distinct set of beams of a same PMI quantity.

In one or more embodiments, the second indication corresponding to the selection of the beam combination corresponds to a permutation/sub-selection of beam values of the beam combination of the plurality of beam combinations. In one or more particular embodiments, a third indication of a permutation index corresponding to the permutation of the beam values of the beam combination is reported in the CSI report. In one or more specific embodiments, the third indication is reported in a second part of the two parts of the CSI report.

In one or more embodiments, the second set of CSI-RS segments is a subset/strictly smaller than of the first set of CSI-RS segments. In one or more particular embodiments, a number of beams associated with a first CSI-RS segment that corresponds to the first set of CSI-RS segments and not the second set of CSI-RS segments (i.e., a set of a difference of the first set and the second set) is larger than a smallest number of beams associated with a second CSI-RS segment that corresponds to the second set of CSI-RS segments. In one or more specific embodiments, the UE substitutes the number of beams associated with the first CSI-RS segment with the number of beams associated with the second CSI-RS segment. In one or more particular embodiments, the UE determines a maximum sum of a number of beams associated with the CSI-RS segments of the second set of CSI-RS segments based on a summation of a number of beams corresponding to the selection of the beam combination. In one or more specific embodiments, the number of beams associated with each CSI-RS segment of the second set of CSI-RS segments is constrained by the maximum sum of the number of beams, and by a set of allowable number of beams from a pre-determined codebook of values of the number of beams. In one or more specific embodiments, the number of beams associated with each CSI-RS segment of the second set of CSI-RS segments is reported in the second part of the two parts of the CSI report.

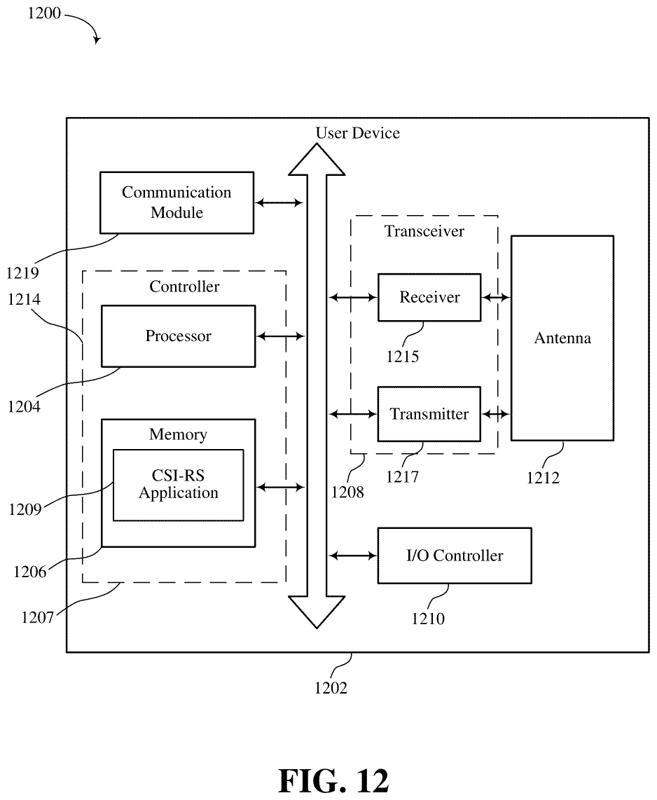

FIG. 12 illustrates an example of a block diagram 1200 of a user device 1202 that supports efficient control signaling for channel state information (CSI) by collaborating with a network device in selecting simultaneously transmitting network devices and number of beams per network device with CSI reporting adjusted to match uplink resources. The user device 1202 may be an example of a UE 104 (FIG. 1) as described herein. The user device 1202 may support wireless communication with one or more network entities or network devices 102, UEs 104, or any combination thereof. The user device 1202 may include components for bi-directional communications including components for transmitting and receiving communications, such as a processor 1204, a memory 1206, a transceiver 1208, and an I/O controller 1210. These components may be in electronic communication or otherwise coupled (e.g., operatively, communicatively, functionally, electronically, electrically) via one or more interfaces (e.g., buses).

The processor 1204, the memory 1206, the transceiver 1208, or various combinations thereof or various components thereof may be examples of means for performing various aspects of the present disclosure as described herein. For example, the processor 1204, the memory 1206, the transceiver 1208, or various combinations or components thereof may support a method for performing one or more of the operations described herein.

In some implementations, the processor 1204, the memory 1206, the transceiver 1208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 1207 includes the processor 1204 that configures the user device 1202 to perform the functionality of the present disclosure. The controller 1207 is communicatively coupled to the memory 1206 to execute program code. Controller 1207 may include dedicated memory solely accessible by the processor 1204 that is a portion of memory 1206. In some implementations, the processor 1204 and the memory 1206 coupled with the processor 1204 may be configured to perform one or more of the functions as a controller 1207 described herein (e.g., executing, by the processor 1204, instructions stored in the memory 1206). In an example, the processor 1204 of a device controller 1214 executes CSI-RS application 1209 to configure user device 1202 for performing CSI measurement and reporting.

The processor 1204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1204 may be configured to operate a memory array using a memory controller. In some other implementations, a memory controller may be integrated into the processor 1204. The processor 1204 may be configured to execute computer-readable instructions stored in a memory (e.g., the memory 1206) to cause the user device 1202 to perform various functions of the present disclosure.

The memory 1206 may include random access memory (RAM) and read-only memory (ROM). The memory 1206 may store computer-readable, computer-executable code including instructions that, when executed by the processor 1204 cause the user device 1202 to perform various functions described herein. The code may be stored in a non-transitory computer-readable medium such as system memory or another type of memory. In some implementations, the code may not be directly executable by the processor 1204 but may cause a computer (e.g., when compiled and executed) to perform functions described herein. In some implementations, the memory 1206 may include, among other things, a basic input/output (I/O) system (BIOS) which may control basic hardware or software operation such as the interaction with peripheral components or devices.

The I/O controller 1210 may manage input and output signals for the user device 1202. The I/O controller 1210 may also manage peripherals not integrated into the user device 1202. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. In some implementations, the I/O controller 1210 may be implemented as part of a processor, such as the processor 1204. In some implementations, a user may interact with the user device 1202 via the I/O controller 1210 or via hardware components controlled by the I/O controller 1210.

In some implementations, the user device 1202 may include a single antenna 1212. However, in some other implementations, the user device 1202 may have more than one antenna 1212 (i.e., multiple antennas), including multiple antenna panels or antenna arrays, which may be capable of concurrently transmitting or receiving multiple wireless transmissions. The transceiver 1208 may communicate bi-directionally using one or more receivers 1215 and one or more transmitters 1217, via the one or more antennas 1212, wired, or wireless links as described herein. For example, the transceiver 1208 may represent a wireless transceiver and may communicate bi-directionally with another wireless transceiver. The transceiver 1208 may also include a modem to modulate the packets, to provide the modulated packets to one or more antennas 1212 for transmission, and to demodulate packets received from the one or more antennas 1212. The user device 1202 has the at least one transceiver 1208 that includes at least one receiver 1215 and at least one transmitter 1217 that enable the user device 1202 to communicate with a network entity or network device 102a and to a user device such as UE 104a (FIG. 1).

The user device 1202 may include a communication module 1219 that is communicatively coupled to the controller 1214. In some implementations, the communication module 1219 may be configured to perform various operations (e.g., receiving, monitoring, transmitting) using or otherwise in cooperation with the receiver 1215, the transmitter 1217, or both. For example, the communication module 1219 may receive information from the receiver 1215, send information to the transmitter 1217, or be integrated in combination with the receiver 1215, the transmitter 1217, or both to receive information, transmit information, or perform various other operations as described herein. Although the communication module 1219 is illustrated as a separate component, in some implementations, one or more functions described with reference to the communication module 1219 may be supported by or performed by a processing subsystem such as controller 1214, the memory 1206, or any combination thereof. For example, the memory 1206 may store code, which may include instructions executable by the controller 1214 to cause/configure the user device 1202 to perform various aspects of the present disclosure as described herein, or the controller 1214 and the memory 1206 may be otherwise configured to perform or support such operations.

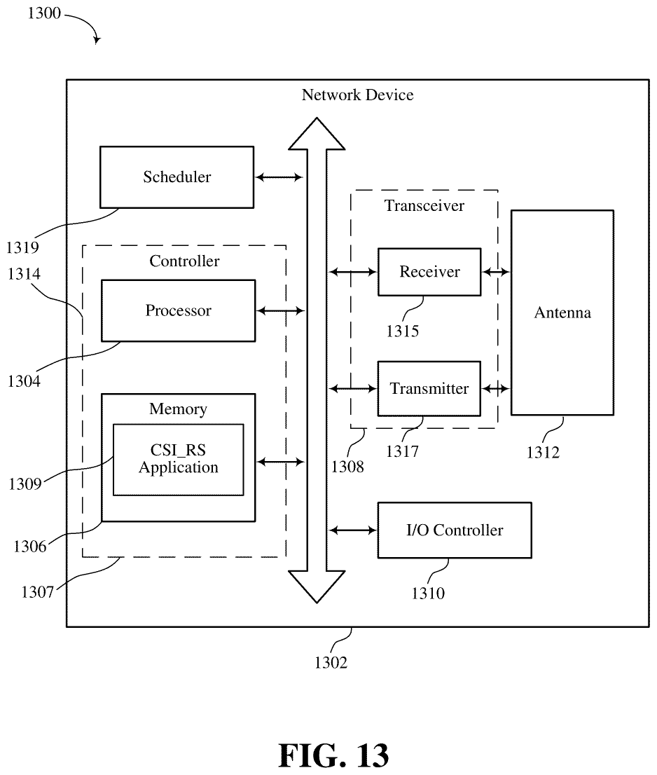

FIG. 13 illustrates an example of a block diagram 1300 of a network device 1302 that supports efficient control signaling for channel state information (CSI) by collaborating with a user device. The collaboration includes selecting simultaneously transmitting network devices and number of beams per network device with CSI reporting adjusted by the user device to match uplink resources. The network device 1302 may be an example of a network entity or network device 102 (FIG. 1) as described herein. The network device 1302 may support wireless communication with one or more network entities or network devices 102, UEs 104, or any combination thereof. The network device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses).

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 1307 includes the processor 1304 that configures the network device 1302 to perform the functionality of the present disclosure. The controller 1307 is communicatively coupled to the memory 1306 to execute program code. Controller 1307 may include dedicated memory solely accessible by the processor 1304, that is a portion of memory 1306. In some implementations, the processor 1304 and the memory 1306 coupled with the processor 1304 may be configured to perform one or more of the functions as a controller 1307 described herein (e.g., executing, by the processor 1304, instructions stored in the memory 1306). In an example, the processor 1304 of a device controller 1314 executes a CSI-RS application 1309 to configure UE 104 (FIG. 1) for CSI-RS measurement and reporting.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the network device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the network device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the network device 1302. The I/O controller 1310 may also manage peripherals not integrated into the device M02. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor 1304. In some implementations, a user may interact with the network device 1302 via the I/O controller 1310 or via hardware components controlled by the I/O controller 1310.

In some implementations, the network device 1302 may include a single antenna 1312. However, in some other implementations, the network device 1302 may have more than one antenna 1312 (i.e., multiple antennas), including multiple antenna panels or antenna arrays, which may be capable of concurrently transmitting or receiving multiple wireless transmissions. The transceiver 1308 may communicate bi-directionally using one or more receivers 1315 and one or more transmitters 1317, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

The network device 1302 may include a scheduler 1319 that is communicatively coupled to the controller 1314. In some implementations, the scheduler 1319 may be configured to perform various operations (e.g., receiving, monitoring, transmitting) using or otherwise in cooperation with the receiver 1315, the transmitter 1317, or both. For example, the scheduler 1319 may receive information from the receiver 1315, send information to the transmitter 1317, or be integrated in combination with the receiver 1315, the transmitter 1317, or both to receive information, transmit information, or perform various other operations as described herein. Although the scheduler 1319 is illustrated as a separate component, in some implementations, one or more functions described with reference to the scheduler 1319 may be supported by or performed by a processing subsystem such as controller 1314, the memory 1306, or any combination thereof. For example, the memory 1306 may store code, which may include instructions executable by the controller 1314 to cause/configure the network device 1302 to perform various aspects of the present disclosure as described herein, or the controller 1314 and the memory 1306 may be otherwise configured to perform or support such operations.

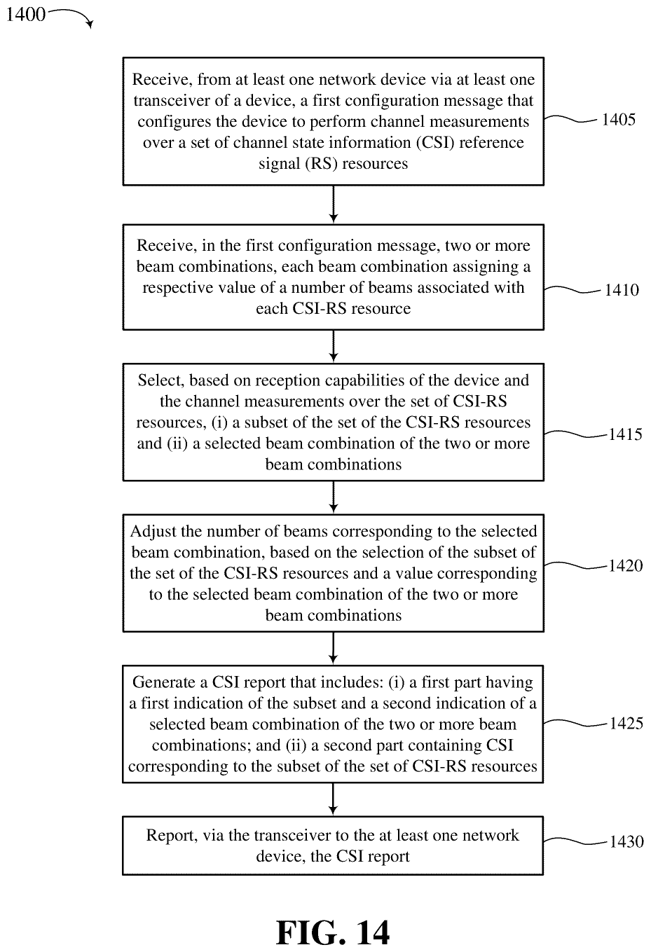

FIG. 14 illustrates a flowchart of a method 1400 for wireless communication at a user device that supports efficient control signaling for channel state information (CSI) by collaborating with a network device in selecting simultaneously transmitting network devices and number of beams per network device with CSI reporting adjusted to match uplink resources, in accordance with aspects of the present disclosure. The operations of the method 1400 may be implemented by a device or its components as described herein. For example, the operations of the method 1400 may be performed by a user device such as UE 104 (FIG. 1) or user device 1202 (FIG. 12). In some implementations, the user device may execute a set of instructions to control the function elements of the network device to perform the described functions. Additionally, or alternatively, the user device may perform aspects of the described functions using special-purpose hardware.

At 1405, the method 1400 may include receiving from at least one network device via at least one transceiver of a device, a first configuration message that configures the device to perform channel measurements over a set of channel state information (CSI) reference signal (RS) resources. The operations of 1405 may be performed in accordance with examples as described herein. In some implementations, aspects of the operations of 1405 may be performed by a device as described with reference to FIGS. 1 and 12.

At 1410, the method 1400 may include receiving, in the first configuration message, two or more beam combinations, each beam combination assigning a respective value of a number of beams associated with each CSI-RS resource. The operations of 1410 may be performed in accordance with examples as described herein. In some implementations, aspects of the operations of 1410 may be performed by a device as described with reference to FIGS. 1 and 12.

At 1415, the method 1400 may include selecting, based on reception capabilities of the device and the channel measurements over the set of CSI-RS resources, (i) a subset of the set of the CSI-RS resources and (ii) a selected beam combination of the two or more beam combinations. The operations of 1415 may be performed in accordance with examples as described herein. In some implementations, aspects of the operations of 1415 may be performed by a device as described with reference to FIGS. 1 and 12.

At 1420, the method 1400 may include adjusting the number of beams corresponding to the selected beam combination, based on the selection of the subset of the set of the CSI-RS resources and a value corresponding to the selected beam combination of the two or more beam combinations. The operations of 1420 may be performed in accordance with examples as described herein. In some implementations, aspects of the operations of 1420 may be performed by a device as described with reference to FIGS. 1 and 12.

At 1425, the method 1400 may include generating a CSI report that includes: (i) a first part having a first indication of the subset and a second indication of a selected beam combination of the two or more beam combinations; and (ii) a second part containing CSI corresponding to the subset of the set of CSI-RS resources. The operations of 1425 may be performed in accordance with examples as described herein. In some implementations, aspects of the operations of 1425 may be performed by a device as described with reference to FIGS. 1 and 12.

At 1430, the method 1400 may include reporting, via the transceiver to the at least one network device, the CSI report. The operations of 1430 may be performed in accordance with examples as described herein. In some implementations, aspects of the operations of 1430 may be performed by a device as described with reference to FIGS. 1 and 12.

According to one or more aspects of the present disclosure, the method 1400 may include configuring the device, based on a received setting within the first configuration message, to adjust the number of beams corresponding to the selected beam combination by using respective numbers of beams contained in the selected beam combination in an order selected by the device. The respective number of beams are permuted with respect to the CSI-RS resources of the subset of the set of the CSI-RS resources. In one or more particular embodiments, the method 1400 may further include reporting an indication of the order in the second part of the CSI report.

In one or more embodiments, the method 1400 may include configuring the device, based on a received setting within the first configuration message, to adjust the number of beams corresponding to the selected beam combination by using a higher value of a number of beams assigned to a first CSI-RS resource that is not in the subset, instead of a lower value of a number of beams assigned to a second CSI-RS resource that is in the subset.

In one or more embodiments, the method 1400 may include deriving a constraint on a sum of the number of beams assigned to the subset of the set of the CSI-RS resources. The constraint is based on a sum of the number of beams associated with the selected beam combination. The constraint is derived only if the subset of the set of the CSI-RS resources is smaller than the set of the CSI-RS resources. In one or more particular embodiments, the method 1400 may further include configuring the device, based on a received setting within the first configuration message, to adjust the number of beams corresponding to the selected beam combination by selecting a number of beams assigned to each CSI-RS resource of the subset of the CSI-RS resource. A sum of the selected number of beams satisfies the constraint on the sum of the number of beams. In one or more particular embodiments, the method 1400 may further include reporting, in the second part of the CSI report, an indication of the selected number of beams assigned to each CSI-RS resource. In one or more particular embodiments, the method 1400 may further include selecting the number of beams assigned to each CSI-RS resource from a codebook comprising a set of possible values of the number of beams assigned to each CSI-RS resource, and wherein the codebook includes values 2, 4, and 6.

In one or more embodiments, the method 1400 may further include receiving a second configuration message comprising a Transmission Configuration Indicator (TCI) codepoint corresponding to a same Demodulation Reference Signal (DMRS) for a physical downlink shared channel (PDSCH), the DMRS for PDSCH being quasi co-located with the set of the CSI-RS resources in a form of a plurality of TCI states indicated in the TCI codepoint.

In one or more embodiments, the method 1400 may further include generating the CSI report comprising a set of precoding matrix indicator (PMI) segments within the CSI report. Each PMI segment is associated with a distinct CSI-RS resource within the subset of the CSI-RS resources. In one or more particular embodiments, the method 1400 may further include each PMI segment corresponds to at least one of: (i) a distinct set of beams of a same PMI quantity; (ii) a distinct set of non-zero power CSI-RS ports of the subset of the set of the CSI-RS resources; and (iii) a distinct PMI quantity.

In one or more embodiments, the method 1400 may further include each CSI-RS resource corresponds to a network device, and each network device comprises one of: (i) an antenna panel; (ii) a transmission reception point (TRP); and (iii) a remote radio head (RHH).

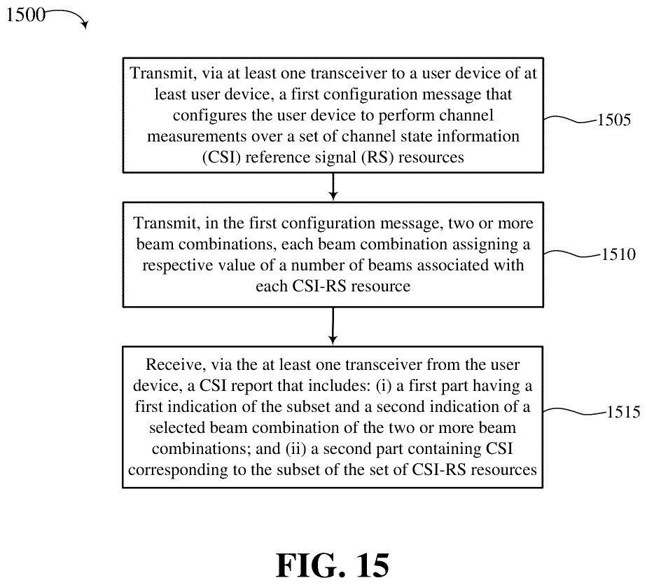

FIG. 15 illustrates a flowchart of a method 1500 for wireless communication at a network device that that supports efficient control signaling for channel state information (CSI) by collaborating with a user device in selecting simultaneously transmitting network devices and number of beams per network device with CSI reporting adjusted to match uplink resources, in accordance with aspects of the present disclosure. The operations of the method 1500 may be implemented by a device or its components as described herein. For example, the operations of the method 1500 may be performed by a network device such as network device 102 (FIGS. 1 and 13). In some implementations, the network device may execute a set of instructions to control the function elements of the network device to perform the described functions. Additionally, or alternatively, the network device may perform aspects of the described functions using special-purpose hardware.

At 1505, the method 1500 may include transmitting, via at least one transceiver to a user device of at least user device, a first configuration message that configures the user device to perform channel measurements over a set of channel state information (CSI) reference signal (RS) resources. The operations of 1505 may be performed in accordance with examples as described herein. In some implementations, aspects of the operations of 1505 may be performed by a device as described with reference to FIGS. 1 and 13.

At 1510, the method 1500 may include transmitting, in the first configuration message, two or more beam combinations, each beam combination assigning a respective value of a number of beams associated with each CSI-RS resource. The first configuration prompts the user device to select, based on reception capabilities of the user device and the channel measurements over the set of CSI-RS resources, (i) a subset of the set of the CSI-RS resources and (ii) a selected beam combination of the two or more beam combinations. The first configuration prompts the user device to adjust the number of beams corresponding to the selected beam combination, based on the selection of the subset of the set of the CSI-RS resources and a value corresponding to the selected beam combination of the two or more beam combinations. The operations of 1510 may be performed in accordance with examples as described herein. In some implementations, aspects of the operations of 1510 may be performed by a device as described with reference to FIGS. 1 and 13.

At 1515, the method 1500 may include receiving, via the at least one transceiver from the user device, a CSI report that includes: (i) a first part having a first indication of the subset and a second indication of a selected beam combination of the two or more beam combinations; and (ii) a second part containing CSI corresponding to the subset of the set of CSI-RS resources. The operations of 1515 may be performed in accordance with examples as described herein. In some implementations, aspects of the operations of 1515 may be performed by a device as described with reference to FIGS. 1 and 13.

According to one or more aspects of the present disclosure, the method 1500 may further include transmitting the first configuration message to configure the user device, based on a received setting within the first configuration message, to adjust the number of beams corresponding to the selected beam combination by using respective numbers of beams contained in the selected beam combination in an order selected by the user device. The respective number of beams are permuted with respect to the CSI-RS resources of the subset of the set of the CSI-RS resources. In one or more particular embodiments, an indication of the order is reported in the second part of the CSI report.

In one or more embodiments, the method 1500 may further include configuring the device, based on a received setting within the first configuration message, to adjust the number of beams corresponding to the selected beam combination by using a higher value of a number of beams assigned to a first CSI-RS resource that is not in the subset, instead of a lower value of a number of beams assigned to a second CSI-RS resource that is in the subset.

In one or more embodiments, the method 1500 may further include transmitting the first configuration message to configure the user device to derive a constraint on a sum of the number of beams assigned to the subset of the set of the CSI-RS resources, wherein the constraint is based on a sum of the number of beams associated with the selected beam combination, and wherein the constraint is derived only if the subset of the set of the CSI-RS resources is smaller than the set of the CSI-RS resources. In one or more particular embodiments, the method 1500 may further include transmitting the first configuration message to configure the user device, based on a received setting within the first configuration message, to adjust the number of beams corresponding to the selected beam combination by selecting a number of beams assigned to each CSI-RS resource of the subset of the CSI-RS resource, wherein a sum of the selected number of beams satisfies the constraint on the sum of the number of beams. In one or more specific embodiments, the method 1500 may further include receiving, in the second part of the CSI report, an indication of the selected number of beams assigned to each CSI-RS resource. In one or more specific embodiments, the method 1500 may further include transmitting the first configuration message configures the user device to select the number of beams assigned to each CSI-RS resource from a codebook comprising a set of possible values of the number of beams assigned to each CSI-RS resource, and wherein the codebook includes values 2, 4, and 6.

In one or more embodiments, the method 1500 may further include transmitting a second configuration message comprising a Transmission Configuration Indicator (TCI) codepoint corresponding to a same Demodulation Reference Signal (DMRS) for a physical downlink shared channel (PDSCH), the DMRS for PDSCH being quasi co-located with the set of the CSI-RS resources in a form of a plurality of TCI states indicated in the TCI codepoint.

In one or more embodiments, the method 1500 may further include transmitting the first configuration message configures the user device to generate the CSI report comprising a set of precoding matrix indicator (PMI) segments within the CSI report, each PMI segment being associated with a distinct CSI-RS resource within the subset of the CSI-RS resources. In one or more particular embodiments, each PMI segment corresponds to at least one of: (i) a distinct set of beams of a same PMI quantity; (ii) a distinct set of non-zero power CSI-RS ports of the subset of the set of the CSI-RS resources; and (iii) a distinct PMI quantity. In one or more embodiments, each CSI-RS resource corresponds to a network device, and each network device comprises one of: (i) an antenna panel; (ii) a transmission reception point (TRP); and (iii) a remote radio head (RHH).

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the UE comprising:
at least one memory; and
at least one processor communicatively coupled to the at least one memory and configured to cause the UE to:
receive, from at least one base station, a first configuration message that configures the UE to perform channel measurements over a set of channel state information (CSI) reference signal (RS) resources;
receive, in the first configuration message, two or more beam combinations, each beam combination assigning a respective value of a number of beams associated with each CSI-RS resource;
select, based on reception capabilities of the UE and the channel measurements over the set of CSI-RS resources, (i) a subset of the set of the CSI-RS resources and (ii) a selected beam combination of the two or more beam combinations;
adjust the number of beams corresponding to the selected beam combination, based on the selection of the subset of the set of the CSI-RS resources and a value corresponding to the selected beam combination of the two or more beam combinations;
generate a CSI report that includes: (i) a first part having a first indication of the subset and a second indication of a selected beam combination of the two or more beam combinations; and (ii) a second part containing CSI corresponding to the subset of the set of CSI-RS resources; and
report the CSI report via the transceiver to the at least one base station.

2. The UE of claim 1, wherein the at least one processor is configured to cause the UE to:
based on a received setting within the first configuration message, adjust the number of beams corresponding to the selected beam combination by using respective numbers of beams contained in the selected beam combination in an order selected by the UE, wherein the respective number of beams are permuted with respect to the CSI-RS resources of the subset of the set of the CSI-RS resources; and
report an indication of the order in the second part of the CSI report.

3. The UE of claim 1, wherein the at least one processor is configured to cause the UE to, based on a received setting within the first configuration message, adjust the number of beams corresponding to the selected beam combination by using a higher value of a number of beams assigned to a first CSI-RS resource that is not in the subset, instead of a lower value of a number of beams assigned to a second CSI-RS resource that is in the subset.

4. The UE of claim 1, wherein the at least one processor is configured to cause the UE to:
derive a constraint on a sum of the number of beams assigned to the subset of the set of the CSI-RS resources, wherein the constraint is based on a sum of the number of beams associated with the selected beam combination, and wherein the constraint is derived only if the subset of the set of the CSI-RS resources is smaller than the set of the CSI-RS resources;
configure the UE, based on a received setting within the first configuration message, to adjust the number of beams corresponding to the selected beam combination by selecting a number of beams assigned to each CSI-RS resource of the subset of the CSI-RS resource, wherein a sum of the selected number of beams satisfies the constraint on the sum of the number of beams; and
report, in the second part of the CSI report, an indication of the selected number of beams assigned to each CSI-RS resource.

5. The UE of claim 1, wherein the at least one processor is configured to cause the UE to select the number of beams assigned to each CSI-RS resource from a codebook comprising a set of possible values of the number of beams assigned to each CSI-RS resource, and wherein the codebook includes values 2, 4, and 6.

6. The UE of claim 1, wherein the at least one processor is configured to cause the UE to receive a second configuration message comprising a Transmission Configuration Indicator (TCI) codepoint corresponding to a same Demodulation Reference Signal (DMRS) for a physical downlink shared channel (PDSCH), the DMRS for PDSCH being quasi co-located with the set of the CSI-RS resources in a form of a plurality of TCI states indicated in the TCI codepoint.

7. The UE of claim 1, wherein:
the at least one processor is configured to cause the UE to generate the CSI report comprising a set of precoding matrix indicator (PMI) segments within the CSI report, each PMI segment being associated with a distinct CSI-RS resource within the subset of the CSI-RS resources; and
each PMI segment corresponds to at least one of: (i) a distinct set of beams of a same PMI quantity; (ii) a distinct set of non-zero power CSI-RS ports of the subset of the set of the CSI-RS resources; and (iii) a distinct PMI quantity.

8. A controller for wireless communication, the controller comprising:
at least one processor coupled with at least one memory and configured to cause the controller to:
receive, from at least one base station, a first configuration message that configures the UE to perform channel measurements over a set of channel state information (CSI) reference signal (RS) resources;
receive, in the first configuration message, two or more beam combinations, each beam combination assigning a respective value of a number of beams associated with each CSI-RS resource;
select, based on reception capabilities of the UE and the channel measurements over the set of CSI-RS resources, (i) a subset of the set of the CSI-RS resources and (ii) a selected beam combination of the two or more beam combinations;
adjust the number of beams corresponding to the selected beam combination, based on the selection of the subset of the set of the CSI-RS resources and a value corresponding to the selected beam combination of the two or more beam combinations;
generate a CSI report that includes: (i) a first part having a first indication of the subset and a second indication of a selected beam combination of the two or more beam combinations; and (ii) a second part containing CSI corresponding to the subset of the set of CSI-RS resources; and
reports the CSI report to the at least one base station.

9. The controller of claim 8, wherein the at least one processor is configured to cause the controller to:
based on a received setting within the first configuration message, adjust the number of beams corresponding to the selected beam combination by using respective numbers of beams contained in the selected beam combination in an order selected by the UE, wherein the respective number of beams are permuted with respect to the CSI-RS resources of the subset of the set of the CSI-RS resources; and
report an indication of the order in the second part of the CSI report.

10. The controller of claim 8, wherein the at least one processor is configured to cause the controller to, based on a received setting within the first configuration message, adjust the number of beams corresponding to the selected beam combination by using a higher value of a number of beams assigned to a first CSI-RS resource that is not in the subset, instead of a lower value of a number of beams assigned to a second CSI-RS resource that is in the subset.

11. The controller of claim 8, wherein the at least one processor is configured to cause the controller to:
derive a constraint on a sum of the number of beams assigned to the subset of the set of the CSI-RS resources, wherein the constraint is based on a sum of the number of beams associated with the selected beam combination, and wherein the constraint is derived only if the subset of the set of the CSI-RS resources is smaller than the set of the CSI-RS resources;
configure the UE, based on a received setting within the first configuration message, to adjust the number of beams corresponding to the selected beam combination by selecting a number of beams assigned to each CSI-RS resource of the subset of the CSI-RS resource, wherein a sum of the selected number of beams satisfies the constraint on the sum of the number of beams; and
report, in the second part of the CSI report, an indication of the selected number of beams assigned to each CSI-RS resource.

12. A method performed by a user equipment (UE), the method comprising:
receiving, from at least one base station, a first configuration message that configures the UE to perform channel measurements over a set of channel state information (CSI) reference signal (RS) resources;
receiving, in the first configuration message, two or more beam combinations, each beam combination assigning a respective value of a number of beams associated with each CSI-RS resource;
selecting, based on reception capabilities of the UE and the channel measurements over the set of CSI-RS resources, (i) a subset of the set of the CSI-RS resources and (ii) a selected beam combination of the two or more beam combinations;
adjusting the number of beams corresponding to the selected beam combination, based on the selection of the subset of the set of the CSI-RS resources and a value corresponding to the selected beam combination of the two or more beam combinations;
generating a CSI report that includes: (i) a first part having a first indication of the subset and a second indication of a selected beam combination of the two or more beam combinations; and (ii) a second part containing CSI corresponding to the subset of the set of CSI-RS resources; and
reporting the CSI report via a transceiver of the UE to the at least one network device base station.

13. The method of claim 12, further comprising:
configuring the UE, based on a received setting within the first configuration message, to adjust the number of beams corresponding to the selected beam combination by using respective numbers of beams contained in the selected beam combination in an order selected by the UE, wherein the respective number of beams are permuted with respect to the CSI-RS resources of the subset of the set of the CSI-RS resources; and
reporting an indication of the order in the second part of the CSI report.

14. The method of claim 12, further comprising configuring the UE, based on a received setting within the first configuration message, to adjust the number of beams corresponding to the selected beam combination by using a higher value of a number of beams assigned to a first CSI-RS resource that is not in the subset, instead of a lower value of a number of beams assigned to a second CSI-RS resource that is in the subset.

15. The method of claim 12, further comprising:
deriving a constraint on a sum of the number of beams assigned to the subset of the set of the CSI-RS resources, wherein the constraint is based on a sum of the number of beams associated with the selected beam combination, and wherein the constraint is derived only if the subset of the set of the CSI-RS resources is smaller than the set of the CSI-RS resources;
configuring the UE, based on a received setting within the first configuration message, to adjust the number of beams corresponding to the selected beam combination by selecting a number of beams assigned to each CSI-RS resource of the subset of the CSI-RS resource, wherein a sum of the selected number of beams satisfies the constraint on the sum of the number of beams; and
reporting, in the second part of the CSI report, an indication of the selected number of beams assigned to each CSI-RS resource.

16. The method of claim 12, further comprising receiving a second configuration message comprising a Transmission Configuration Indicator (TCI) codepoint corresponding to a same Demodulation Reference Signal (DMRS) for a physical downlink shared channel (PDSCH), the DMRS for PDSCH being quasi co-located with the set of the CSI-RS resources in a form of a plurality of TCI states indicated in the TCI codepoint.

17. The method of claim 12, further comprising:
generating the CSI report comprising a set of precoding matrix indicator (PMI) segments within the CSI report, each PMI segment being associated with a distinct CSI-RS resource within the subset of the CSI-RS resources;
wherein each PMI segment corresponds to at least one of: (i) a distinct set of beams of a same PMI quantity; (ii) a distinct set of non-zero power CSI-RS ports of the subset of the set of the CSI-RS resources; and (iii) a distinct PMI quantity.

18. A base station for wireless communication, the base station comprising:
at least one memory; and
at least one processor coupled with the at least memory and configured to cause the base station to:
transmit, to a user equipment (UE), a first configuration message that configures the UE to perform channel measurements over a set of channel state information (CSI) reference signal (RS) resources;
transmit, in the first configuration message, two or more beam combinations, each beam combination assigning a respective value of a number of beams associated with each CSI-RS resource, prompting the UE to select, based on reception capabilities of the UE and the channel measurements over the set of CSI-RS resources, (i) a subset of the set of the CSI-RS resources and (ii) a selected beam combination of the two or more beam combinations, and prompting the UE to adjust the number of beams corresponding to the selected beam combination, based on the selection of the subset of the set of the CSI-RS resources and a value corresponding to the selected beam combination of the two or more beam combinations; and
receive, via the at least one transceiver from the UE, a CSI report that includes: (i) a first part having a first indication of the subset and a second indication of a selected beam combination of the two or more beam combinations; and (ii) a second part containing CSI corresponding to the subset of the set of CSI-RS resources.

19. The base station of claim 18, wherein the at least one processor is configured to cause the base station to:
transmit the first configuration message to configure the UE to:
derive a constraint on a sum of the number of beams assigned to the subset of the set of the CSI-RS resources, wherein the constraint is based on a sum of the number of beams associated with the selected beam combination, and wherein the constraint is derived only if the subset of the set of the CSI-RS resources is smaller than the set of the CSI-RS resources; and
based on a received setting within the first configuration message, adjust the number of beams corresponding to the selected beam combination by selecting a number of beams assigned to each CSI-RS resource of the subset of the CSI-RS resource, wherein a sum of the selected number of beams satisfies the constraint on the sum of the number of beams; and
receive, in the second part of the CSI report, an indication of the selected number of beams assigned to each CSI-RS resource.

20. The base station of claim 18, wherein:
the at least one processor is configured to cause the base station to transmit the first configuration message to configure the UE to generate the CSI report comprising a set of precoding matrix indicator (PMI) segments within the CSI report, each PMI segment being associated with a distinct CSI-RS resource within the subset of the CSI-RS resources; and
each PMI segment corresponds to at least one of: (i) a distinct set of beams of a same PMI quantity; (ii) a distinct set of non-zero power CSI-RS ports of the subset of the set of the CSI-RS resources; and (iii) a distinct PMI quantity.
